(19) United States
(12) Patent Application Publication
(10) Pub. No.: US 2023/0145107 A1
(43) Pub. Date: May 11, 2023

(54) KNIFE HANDLE WITH END FACE

(71) Applicant: Zwilling J.A. Henckels AG, Solingen (DE)

(72) Inventors: Thomas KREITZ, Solingen (DE); Dunja TIGGES, Wermelskirchen (DE)

(21) Appl. No.: 17/802,289

(22) PCT Filed: Mar. 10, 2021
(86) PCT No.: PCT/EP2021/056000

§ 371 Date: Aug. 25, 2022

(30) Foreign Application Priority Data
Mar. 23, 2020 (DE) 10 2020 107 849.8

(51) Int. Cl. B25G 1/10

(52) U.S. Cl. CPC B25G 1/10

(57) ABSTRACT

A knife has a handle that is fastened to the knife blade and that has a first recess that opens towards the handle end and is closed by an end cap or end disc which lies in or abuts on the recess. The rear side of the end cap/end disc has at least two tongues molded thereon parallel to the longitudinal axis of the handle and which project into a longitudinal recess which starts from the first recess and projects inwardly in the direction of the knife blade. The inner wall of the longitudinal recess has longitudinal ribs that are parallel to the longitudinal axis of the handle and jut out from opposite wall sides. The free ends of the tongues have on their outer side at least one tooth or a tooth strip which being forced into the longitudinal rib is/are held therein.

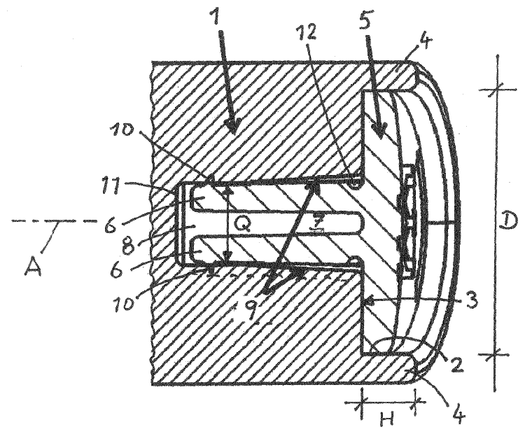

The invention relates to a knife having a handle made of plastic that is fastened to the knife blade and that has a first recess that opens towards the handle end and is closed by an end cap or end disc made of plastic or metal, the end cap/end disc lying in or abutting on the recess, and the rear side of the end cap/end disc having at least two tongues molded thereon that are parallel to the longitudinal axis of the handle and project into a longitudinal recess which starts from the first recess and projects inwardly in the direction of the knife blade.

It is known to cover the end of a knife handle by an end cap that has a pin on its rear side which lies inside a recess of the handle end and is held in the wall of the recess by projections jutting out from the pin (EP 2 503 320 B1). The fastening of the end cap in the handle recess requires substantial press forces.

It is also known to close the end-side opening of a knife handle by an end face which lies within the opening and on the inner side a pin projects which reaches into the opening and is clamped therein.

It is an object of the invention to improve a knife of the kind referred to above in such a way that the end caps or end faces can be simply and easily attached, that allows a tolerance compensation and that ensures a fixed and secure hold.

According to the invention, this object is achieved in that the inner wall of the longitudinal recess has longitudinal ribs made of plastic that are parallel to the longitudinal axis of the handle and jut out from opposite wall sides and the free ends of the tongues have on their outer side at least one tooth or a tooth strip which being forced into the longitudinal rib is/are held therein by clawing engagement.

Such a design of the end cap or end face permits a tolerance compensation and a joining process with minimum effort and low forces also in cold state without warming. This way, a fixed and secure hold in the end of the handle is achieved, even in case of higher dimensional tolerances.

It is important that the tooth or the tooth strip displaces the plastic material of the longitudinal rib through the springy pressure of the tongue and thereby creates a recess in the longitudinal rib in which the tooth or the tooth strip sits with a positive fitting connection. Thus, the longitudinal ribs do not have any recesses for the teeth or the tooth strips before the end cap or end face is pushed into the handle end, but the teeth or tooth strips form their own, in particular undercutting, recess in the longitudinal rib by forcing the material away through their outward pressure. In this respect, the tongues, the teeth and/or tooth strips are made of a harder material than the plastic material of the longitudinal ribs.

Preferably it is proposed that the tongues have at their foot a groove or notch reducing the tongue cross section which increases the springy flexibility of the tongues.

One embodiment of the invention is shown in an axial section with an end disc closing the handle end and is described in more detail below including an alternative.

The blade of a knife has an integral elongate projection (tang) which reaches into the knife handle 1 made of plastic. The knife handle has at the end facing away from the blade and hence at its face side a first opening in the form of a shallow recess 2 the axis of which is parallel or coaxial in relation to the longitudinal axis of the handle 1 or forms an acute angle of 50 to 70 degrees with the longitudinal axis of the handle 1 so that in the latter case, the bottom 3 of the recess 2 is oblique in relation to the longitudinal axis A of the handle.

The recess 2 is surrounded all around by an edge 4 protruding in the direction of the end of the handle, the height H of which edge is ⅕ to 1/10 of the diameter D of the recess 2. Inside the recess 2, a flat disc-like end disc 5 sits with a positive fitting connection which fills the recess 2 at least near the bottom, wherein the edge 4 protrudes beyond the disc-like end disc 5 so that the thickness of the end disc 5 is lower than the height H of the edge 4.

The visible outer face of the end disc 5 made of plastic or metal preferably exhibits an impressed or a raised graphic, in particular a logo. The inner side of the end disc 5 has at least two projecting tongues 6 molded on it that are parallel to one another and that are essentially axially parallel in relation to the longitudinal axis A of the handle and have a small clearance 7 between them.

To receive the two tongues 6, the plastic material of the handle 1 has a longitudinal recess 8 that is coaxial in relation to the axis A and into which the two tongues 6 protrude, wherein the inner wall of the longitudinal recess forms two longitudinal ribs 9 that are approximately parallel in relation to the longitudinal axis A of the handle 1 and are arranged in the longitudinal recess 8 so as to be diametrically opposed to each other.

Both or more tongues 6 have on their outer side near their respective free end a tooth 10 or a tooth strip which press itself/themselves into the plastic of the respective longitudinal rib 9 by forcing away the material when the end disc/end caps has/have been pressed with their tongues 6 into the handle end. In case of a tooth strip, the tooth strip projects from the outside of the respective tongue 6 in transverse direction in relation to the longitudinal axis A. In this respect, the tongues 6, teeth or tooth strips 10 are made of a harder material than the plastic material of the longitudinal ribs 9.

Preferably the longitudinal recess 8 has a cross-section diameter Q that decreases towards the bottom 11 of the longitudinal recess 8 so that the pressure of the teeth 10 or tooth strips exerted on the longitudinal ribs 9 increases the deeper the tongues 6 penetrate into the longitudinal recess 8. A particular secure hold is achieved if the tooth or the tooth strip creates an undercut groove across the longitudinal rib 9.

The longitudinal ribs 9 do not have a recess for the teeth 10 or the tooth strips of the tongue 6, but the teeth 10 or tooth strips of the tongue 6 form their own recesses in the longitudinal ribs 9 through their springy pressure exerted on the longitudinal ribs 9, wherein the tongues maintain their pressure against the longitudinal ribs 9 after the pressing in of the end disc/end caps into the handle end so that the self-created recesses grow in their size over time and the hold is improved.

The tongues 6 may have a reduction in the material (notch 12 or groove in their foot zone near the end disc 5, which allows a definition of the strength of the spring force of the tongues.

The end disc/end cap 5 with its tongues 6 is made of metal or a plastic. In the latter case, the plastic of the tongues, the teeth and/or the tooth strips 10 has a higher hardness than the plastic of the handle 1 and of the longitudinal ribs 9.

Instead of an end disc, an end cap may be used which does not lie inside a recess 2 but fully covers the end faces of the handle end on the outside. Also on the rear side of the end caps, tongues 6 project that extend into the longitudinal recess 8 and in the same way engage with a tooth or a tooth strip in ribs 9.

1. A knife, comprising a handle that is made of plastic and is fastened to a knife blade, the handle having a first recess that opens towards an end of the handle and is closed by an end cap or end disc made of plastic or metal, the end cap or end disc lying in or abutting on the first recess, and a rear side of the end cap or end disc having at least two tongues molded thereon that are parallel to a longitudinal axis of the handle and project into a longitudinal recess that starts from the first recess and projects inwardly in a direction of the knife blade, wherein opposite inner wall sides of the longitudinal recess have longitudinal ribs made of plastic that are parallel to the longitudinal axis of the handle and jut out from the opposite inner wall sides and free ends of the tongues have on an outer side thereof at least one tooth or a tooth strip comprising a plurality of teeth, the at least one tooth or the teeth of the tooth strip upon being forced into the longitudinal ribs are held therein by clawing engagement.

2. The knife according to claim 1, wherein the tooth or the tooth strip and the longitudinal ribs are configured so that the at least one tooth or the teeth of the tooth strip displace the plastic material of the longitudinal ribs through springy pressure applied by the tongues and in this way the teeth form respective recesses in the longitudinal ribs in which recesses the teeth sit with a positive fitting connection.

3. The knife according to claim 2, wherein the tongues, the teeth and/or the tooth strips are made of a harder material than the plastic material of the longitudinal ribs.

4. The knife according to claim 1, wherein the tongues have at a foot end thereof a groove or notch which reduces a cross section of the tongues and increases springy flexibility of the tongues.
